(19) United States
(12) Patent Application Publication
(10) Pub. No.: US 2018/0189473 A1
(43) Pub. Date: Jul. 5, 2018

(54) INTERGRATED WEARABLE SECURITY AND AUTHENTICATION APPARATUS AND METHOD OF USE

(71) Applicant: Peter Solomon, Hollywood, FL (US)

(72) Inventor: Peter Solomon, Hollywood, FL (US)

(21) Appl. No.: 15/399,698

(22) Filed: Jan. 5, 2017

(51) Int. Cl. G06F 21/36; G06F 3/01; G06F 1/16; G06K 9/00; G06F 21/32

(52) U.S. Cl. CPC G06F 21/36; G06F 3/017; G06F 21/32; G06K 9/00288; G06F 1/163

(57) ABSTRACT

Embodiments shown provide a wearable device capable of acquiring images association with an unknown person facial features of the user gesture commands using an integrated wearable security system. The system enables a user to discreetly capture images of individual or environment using an integrated camera, video, and audio component. Once the images have been acquired they are simultaneously transmitted to an integrated digital signal processor where they are compare with pre-programmed information corresponding to an individual or gesture command to determine if a match has been detected. If a match is detected, information corresponding to the unknown person and information found in the public domain are sent to the user smart device. If a gesture command has been made, the digital signal processor while wait for an authentication or command or send an output command to responders if the authentication is not received with a pre-determined period.

### CROSS-REFERENCE TO RELATED APPLICATION

This Non-Provisional patent application claims priority to the pending Provisional application Ser. No. 13/368,050 “An Integrated Wearable Security and Authentication System and Method of Use” filed on Jan. 5, 2016, by Peter Solomon.

### FIELD

The embodiments shown herein relate to an integrated wearable security and authentication system, in particular, an integrated wearable security and authentication system including a pre-programmed software configured to receive data corresponding to at least the facial recognition of an unidentified person or an operator gesture and provide a pre-programmed response based on the received data.

### BACKGROUND

Today most security and law enforcement personnel utilize mobile devices and camera for monitoring a security environment. However, many of these current devices are hindered by their ability to detect a sound, background lighting, or limited transmission range.

In addition, the challenge that remains most prominent is the inability to create a real-time wearable system that may monitor an adjacent space. In many instances it's beneficial to for person or organization to know the people they are interacting with whether in a personal, business or social environment without prior research or background information. For instance, if a law enforcement officer were to make a routine stop and had the ability to transfer facial recognition real-time over a network it could provide invaluable background information, arrest data, and risk assessment without requiring the obtrusive and time-consuming personal identification system currently deployed. Further, for individuals at a social or business networking event, it would be helpful to know the different people and organizations in the space to make interaction more efficient.

Moreover, a system that may provide a user an ability to transmit information and using gestures and authenticate those gestures before transmitting the information over a network could help distress people during robberies as well as people that would like to transmit their favorite images to popular social media sites such as Facebook or YouTube®.

Though there are several prior art references to wearable cameras, authentication systems, and wearable security devices such as U.S. Pat. No. 2014/0294257 to Tussy, U.S. Pat. No. 20140230019 to Civelli et al., and U.S. Pat. No. 8,558,893 to Persson et al., there is no single reference that provides an integrated wearable and authentication device that provides a user an ability to integrate gesture information over a wireless network to provide enhanced security and social interaction.

### SUMMARY OF THE INVENTION

Embodiments described herein include an integrated wearable security and authentication system and methods of use which provides a user an ability to receive and transmit facial and gesture information over a wireless network in real-time. The information transmitted may be personal information associated with the unidentified person based on the facial recognition data received as the detected object pattern or may further include a responsive signal corresponding to a pre-programmed respond store within the memory module of the digital signal processor. The system further includes a global positioning and tracking system provides the operator's location when the responsive signal is to an emergency responder.

The embodiments include a wearable system with an integrated camera electrically connected to a digital signal processor having an integrated memory/storage module. The system is powered by at least a battery. Once an image is received (i.e., object patterns), it is immediately sent to the digital signal processor and compared to a pre-programmed algorithm using a variety of features to determine a match. If a match is not immediately determined at the digital signal processor, the detected object pattern is further sent to a server database where it is compared to a variety of images including the operator's social media platforms to determine a match. If a match is determined, the personal information of the unidentified person is sent along with occupation information to the operator's wireless device over a wireless

In an alternative embodiment, the system and hands-free mobile device further includes a microphone electrically connected to a filter and configured to receive a frequency from unidentified individual and compare with a store frequency by analyzing at least the frequency range of the detected frequency.

In an exemplary embodiment, individual may be identified, and associated information may be transmitted over a network to the user. Specifically, an individual's face or a cropped portion thereof may be received by the integrated camera and receiver and first compared to the stored object pattern and then transmitted over the wireless network to the database servers. If a match is detected with a pre-programmed profile within a memory component, pertinent information about the individual from publics domains may be sent to a smart device (i.e., smartphone, smartwatches, tablets, etc.). The uploaded information may be used by law enforcement for security measure or by an individual in a business setting. For example, if an individual attended a networking event wanted to identify and target specific investors the uploaded information and analysis could help filter those to disclose specific trade information and facilitate collaboration and personal data.

In a further embodiment, the system enables gesture recognition and authentication. The system is configured with a digital signal processor and memory component which contains a pre-programmed algorithm of user gestures to indicate various command signals. For example, the digital signal processor may transmit an emergency message to police department r request emergency response based on the user gestures. Further, the device may be used to upload information over a wireless network such as a Bluetooth or Near Field Communications (NFC) by a plurality of gestures. The system is further configured to validate an authorization request by comparing the recorded gestures with the pre-programmed algorithm stored within its memory component.

In a further embodiment, methods of use described herein enable a user to collect, disseminate, and transmit data using facial recognition and gesture recognition in real-time over a wireless network. Once the data is received by the receiver, the data will be filtered and compared with the memory module to identify possible matches, and then retrieve all public information including analysis associated with the known individual or recognized location. Further, the system provides an ability to share information with other individuals wearing similar devices to enhance collaboration and information sharing. For example, if a user has identified an individual that would like to collaborate with at an event, the system enables the user to provide the individual with personal and business information based on the interaction such as contact information, sales data, advertisements, messages, etc.

Other aspects, advantages, and novel features of the embodiments shown herein will become apparent from the following detailed description in conjunction with the drawings.

### BRIEF DESCRIPTION OF THE DRAWINGS

A more complete understanding of the embodiments shown, and the attendant advantages and features thereof, will be more readily understood by reference to the following detailed descriptions when considered in conjunction with the accompanying drawings wherein:

FIG. 1 is an illustration of the integrated wearable security system;

FIG. 2 is a flowchart illustrating the method of use;

FIG. 3 is a perspective view of the system detached from the operator;

FIG. 4 is a side view of the FIG. 5 is a block diagram of the digital signal processor

FIG. 6 illustrate a view illustrating the facial recognition application of the system;

FIG. 7 is a view illustrating the gesture recognition application of the system

FIG. 8 is an alternative embodiment illustrating the sign language recognition application of the system.

### DETAILED DESCRIPTION

The specific details of a single embodiment or variety of embodiments described herein are set forth in this application. Any specific details of the embodiments are used for demonstration purposes only and no unnecessary limitations or inferences are to be understood therefrom.

The embodiments provide a system which enables the operator to releasably attach the system to their clothing and receive transmit and collect a plurality information from a variety of integrated recognition software contained within a digital signal processor. The embodiments enable a person to receive a pattern corresponding to a facial data or unidentified person or the operator gesture and compare the received object pattern with a plurality of stored patterns within the memory module of the digital signal processor. If an object pattern is determined to a match with a stored object pattern associated with facial recognition, then at least the person data information including occupation will be sent over a wireless network to the operator smart device. However, is the receive object pattern is not determined to be a match with store object pattern within the memory module the digital signal processor is configured to send the object pattern data to database server where is can be compared with a plurality of available information including any social media information belonging to the operator.

Traditional software systems have been used in the past which incorporate facial or emotional recognition by comparing the distance or dimensions between detected object patterns within a plurality pre-programmed object patterns within a memory or storage unit of a microcontroller or digital signal processor. Conversely, there is a plurality of gesture detecting programs which interactive display to exhibit images associated with the operator hand or face. These traditional systems often required proximity between the object and the display surface which would then sense and infer movement of an object to detect a gesture. The detected object is then used to carry out an application or other interactions.

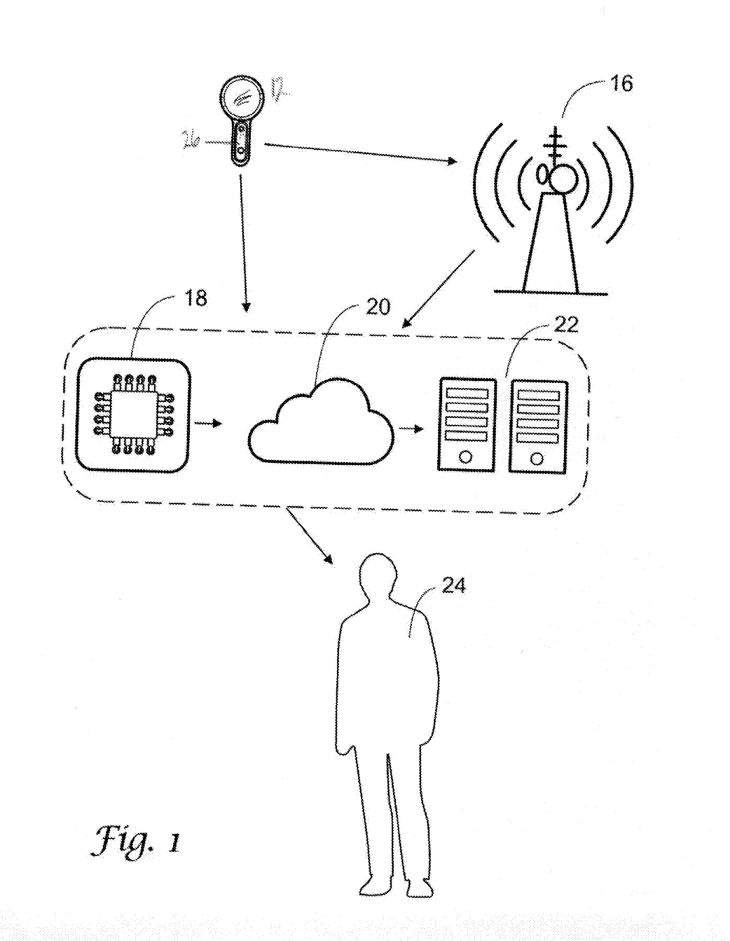

Referring now to the drawings wherein like reference numerals designate identical or corresponding parts throughout the views. There is shown in FIG. 1 an integrated wearable security system 10 configured to receive an object pattern from an unidentified individual or operator and process the received object pattern to determine if a match is made with a plurality of stored object patterns. The system includes a hands-free wearable device 12 electrically connected to a battery which is configured to receive the object pattern and transmit the data over a wireless network 16 where it is compared 18 with information available on a database server or within a digital signal processor 22. If a match is determined between the detected object pattern and a stored object pattern within the database server 20 or digital signal processor, a signal will be sent to the operator's mobile device 24.

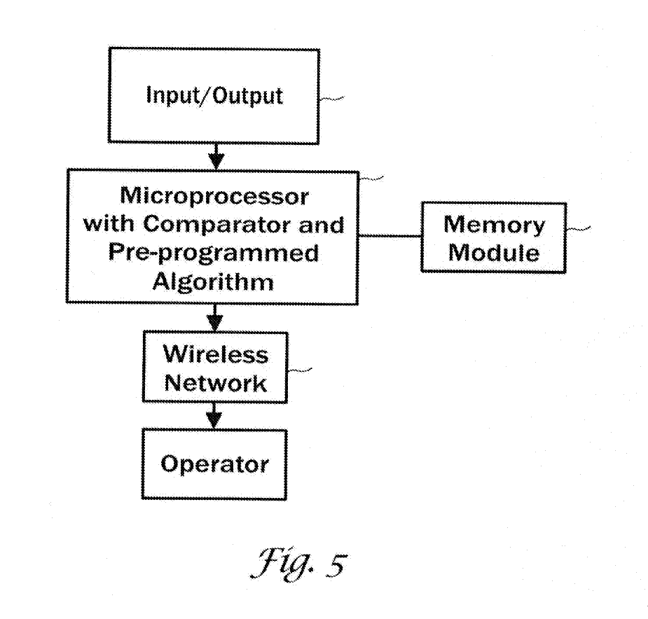

Further illustrated in FIG. 1 is a Bluetooth camera 26 and audio digital processor 28 configured to compare the detected object pattern within a pre-program software algorithm within the digital signal processor 22. The digital signal processor and integrated software when used for facial recognition is capable of analyzing the face of an unidentified person and converting it to biometric data as shown in FIG. 6. This biometric data of the detected object pattern may then be compared using a comparator 18 to the biometric data contained within the digital signal processor for similarities. If a pre-determined percentage of similarity is shared between the detected object pattern, and a stored object pattern then a match will be determined and signal sent to the operator smart device over a wireless network 16.

The detected object pattern is first processed at the system camera 26 and the image is then be cropped, cut, or stored within a memory module 30 of the audio digital processor. The system is configured to crop on a portion of the image to avoid process the entire image and limit the data size transmitted over the wireless network 16, The system 10 is configured to process the detected pattern within the digital signal processor or remotely at the server database 20 and may detected the object pattern from a plurality of available angles. Once the detected object pattern is saved, it may be further cropped or retaken if a low-quality picture has been taken. In this preferred embodiment it is preferable for the detected object pattern to be processed over database server 20 with multiple available processors.

The database server 20 may contain images of unidentified persons and any associated data about the person with the matched object pattern. The data may be any type data selected by the person, by the system, or by a third-party rating entity. Depending on the information found within the database servers 20, different levels of information may be associated with the unidentified person. Based on these factors, different information may be transmitted to the operator.

The system 10 is further configured to process the detected object pattern within the digital signal processor 22 with the plurality of stored object patterns which have been stored within the memory module 30. The detected object pattern is processed and compared to the stored object patterns using a comparator 18 within the digital signal processor. Initially only a portion of face of the unidentified person is used for the detected object pattern which reduces the data size and reduces any bandwidth limitations. The comparator 18 is configured to use compounding probability by matching any known characteristics between the detected object pattern and stored object pattern and may continue to send multiple images of the detected object pattern until a match is determined. Upon determining a match between the detected object pattern and a stored object pattern the data of the unidentified individual is sent to the operators smart device. The data sent to the operator includes at least the name of unidentified individual, occupation, and any share characteristics between the operator and the unidentified individual. For example, if an operator was attending a social networking event and wanted to maximize meeting efficiency they are able to receive object pattern associated to the facial recognition of an unidentified individual and receive the unidentified individual name, business, and share social media groups.

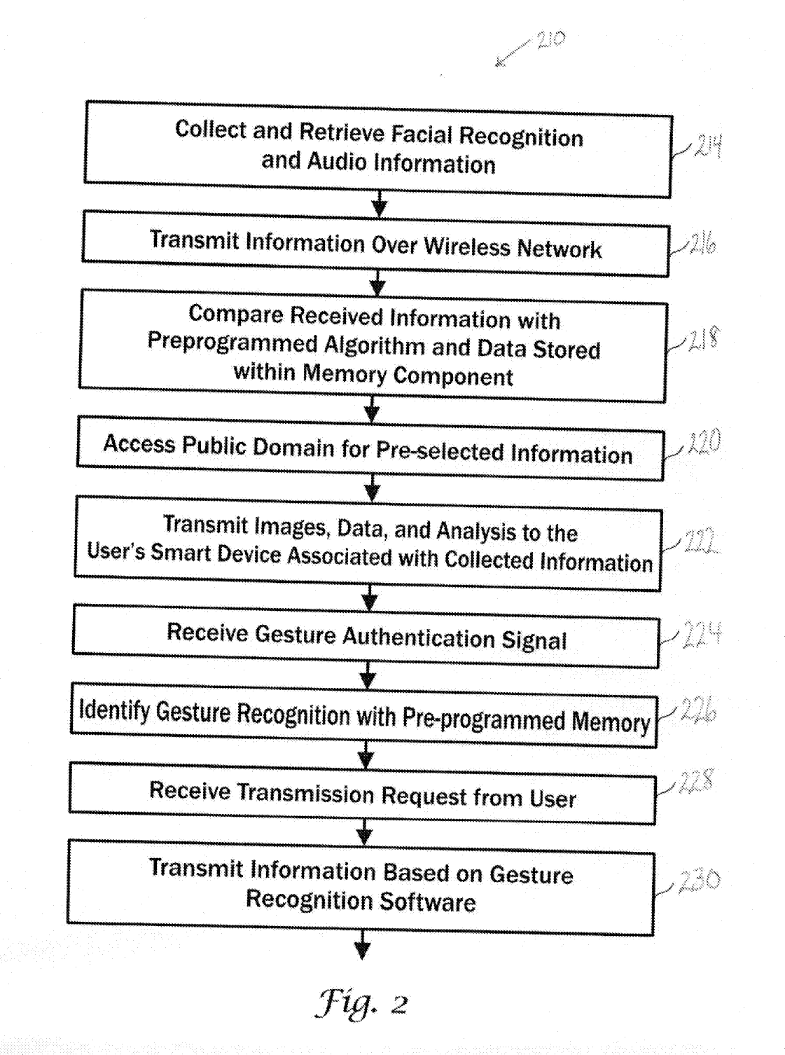

Shown in FIG. 2 is a method 210 of using the system 10 as discussed above. The method 210 includes collecting at least a facial recognition object pattern of unidentified individual using the camera 26 and embedded microphone 32 which collects a plurality of audio information including a detected frequency using a parabolic collector 212. The detected object pattern data is then transmitted over a wireless network 214 where it is compared within store object pattern contained within machine readable algorithm within the digital signal processor 22. Though it is contemplated that a digital signal processor 22 is used, a further processor including a media processor may be used as long as it provides adequate memory for the storage of at least the algorithm.

If a match is not determined between a detected object pattern and a stored object pattern at the comparator 18, the detected object pattern data is transmitted to a server database 20 where it si compared with a variety of information contained in a plurality of servers 218 including any social media platforms of the operator including at least Facebook®, Twitter®, Instagram®, and Linkedin®. The server database 20 may include multiple servers and distributing processors operating together. The server 20 further includes a receiver 34 and transmitter 36 to match pattern object data may be sent to the user smart devices. The server database 20 is may be used to access images which can be used as part of the identification match. Any images and personal information associated with the unidentified person's detected objected pattern is then transmitted to the operator 24 smart device over the wireless network 16. The wireless network 16 includes at least Bluetooth, WIFI, wireless LAN, CDMA, IEEE, broadband access, 3G, 4Gm and wireless USB. Further as discussed above the smart device may further include a PDA, cellular phone, table, smart phone, wireless tablet, or other device capable of computing.

When the system 10 is used to recognize a detected object pattern associated with a facial or gesture and cause a responsive signal based on the detected object pattern. The object pattern signal associated with the gesture is then transmitted to the digital signal processor 22 or over the wireless network 16 to the database server 20, 228 where is received and compared to the stored object pattern within the memory module 30 of the digital signal processor 22. If a match is not determined after a pre-selected time, the gesture is ignored and no information is transmitted to the operator. However, if a match is determined, a pre-programmed response or information associated to the gesture is transmitted.

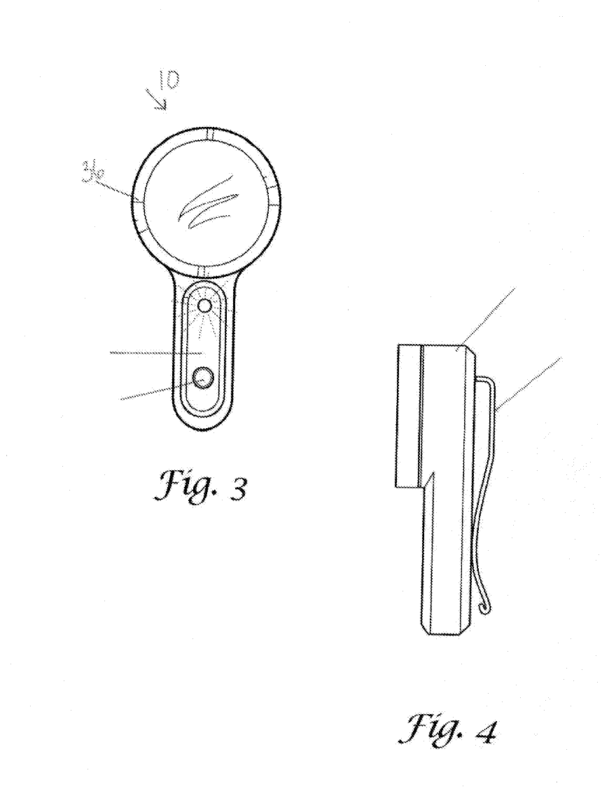

Shown in FIG. 3 is the hands-free wearable device 36 including a translucent portion at the first end 36 which houses a portion of the integrated camera 26 and receiver 39. Further illustrated in FIG. 3 is a flashlight 40 along the handle portion 41 which may serve as a traditional flashlight, a strobe light to deter an attacker, and is further configured to form an object pattern corresponding to a gesture by reflecting back through the translucent portion to the receiver 39 a received object pattern. The received object is then processed to determine proximity to the receiver 39 and identify a potential gesture by measuring a distance on the detected object pattern with a known distance of a stored object pattern corresponding to a gesture. The pre-programmed and stored algorithm is configured to first compare the shape of the detected pattern object with a stored pattern object if a preliminary match is detected the algorithm will mean the distance between corresponding points of the detected object pattern with a stored object pattern to determine a match. If a match is determined, a pre-programmed response associated with the match object pattern is transmitted.

Shown in FIG. 4 is a side view of the wearable device 36 including a clip 42 along the back side 43 configured to be releasably attached to the operator's clothing.

Shown in FIG. 6 the image captured by the mobile device, using facial detection, comprises an image of the unknown person's face. This object pattern which is represented as digital data is transmitted over the network 16 to the database server 20. Using the pre-programmed algorithm within the digital signal processor 22. If a match is not determined at the digital signal processor 22, the image is transmitted over the wireless network 16 where is sent to database server 20 to determine a match.

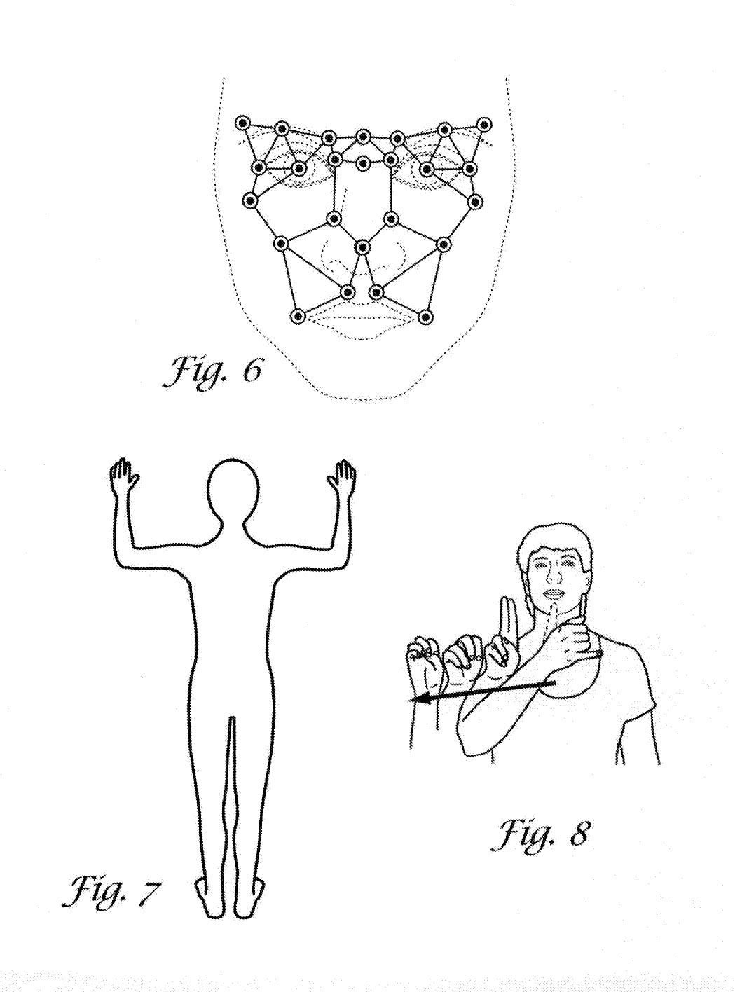

Shown in FIG. 7 is an example of object pattern corresponding to a gesture in which the operator has both hands raised. The object pattern taken from the integrated camera 22 can capture the detected object pattern and transmit the data first the digital signal processor 22 for comparison and then to the database server 22 is a match is not determined with the pre-programmed algorithm within the memory module 30. In the example illustrated in FIG. 7 a pre-programmed signal would likely be transmitted to law enforcement.

Shown in FIG. 8 is a further example of the system 10 and the means in which a match is determined between the detected object pattern and a stored object pattern. In this example, initial shapes of the operator's head and shoulders would be a preliminary match. If a match was determining, the pre-programmed algorithm would measure corresponding measurements on the detected object pattern with stored corresponding measurement of a stored object pattern

It will be appreciated by persons skilled in the art that the present invention is not limited to what has been particularly shown and described hereinabove. In addition, unless mention was made above to the contrary, it should be noted that all of the accompanying drawings are not to scale. A variety of modifications and variations are possible in light of the above teachings without departing from the following claims.

What is claimed is:

1. A hands-free wearable facial and gesture recognition system, the system comprising:
an integrated camera configured to receive an object pattern from at least an operator or an unidentified person;
a digital signal processor having a pre-programmed algorithm and configured to:
receive a digital signal corresponding to the object pattern;
analyze the digital signal to detect a match with a plurality of stored pattern contained within a memory module;
cause a display to a smart device of the operator of at least a personal information associated with the unidentified person; and
transmit a pre-programmed response to an entity based on a match gesture.

2. The system of claim 1, wherein the integrated camera further enables a gesture recognition function.

3. The system of claim 1, further including at least one microphone configured to receive a frequency corresponding to human voice and determine a match using a plurality of pre-programmed frequencies contained in the memory module.

4. The system of claim 3, further including a frequency filter configured to filter a frequency within a pre-determined frequency range.

5. The system of claim 4, wherein the system further includes at least one parabolic collected to enable a frequency to be detected and collected from a plurality of directions.

6. The system of claim 1, wherein the digital signal processor is further configured to transmit pattern object to a database server is a match is not determined at the digital signal processor.

7. The system of claim 4, wherein the database server is further configured to compare the detected object pattern to at least one social platform of the operator.

8. The system of claim 1, further including a global positioning mechanism to provide the operators location to a responsive entity if the pre-programmed response corresponding to an emergency is matched.

9. The system of claim 8, further including a video recorder electrically connected to the integrated camera and configured to selectively record an event.

10. A mobile hand-free wearable facial and gesture recognition system, the system comprising:
an integrated camera configured to receive an object pattern corresponding to a portion of an unidentied person's face or an operator gesture;
a digital signal processor configured to:
receive a detected pattern object from a receiver;
compare the detected pattern object to at least one stored pattern object within a memory module using a pre-programmed algorithm;
determine a match between the detected pattern object and the at least one stored pattern object;
transmit the detected pattern object over a wireless network to a database server is a match is not determined using the pre-programmed algorithm; and
cause an informational packet to be transmitted to a wireless device of an operator if a match is determined using the pre-programmed algorithm.

11. The system of claim 10, wherein the integrated camera is further configured to recognize a detected pattern object corresponding a gesture.

12. The system of claim 11, wherein the integrated camera further includes a high definition video to selectively record an event by the operator.

13. The system of claim 10, further including at least one microphone in communication with a plurality of parabolic collectors and configured to receive a detected frequency.

14. The system of claim 12, further including a frequency filter to enable a detected frequency within a pre-programmed range to be passed to the digital signal processor.

15. The system of claim 10, further including a global positioning mechanism to provide an operators location to at least the responsive entity.

16. A method for detecting a pattern object at least associated with a facial recognition or gesture recognition, the method comprising:
providing a wearable device configured to detect a pattern object using an integrated camera and a wireless transceiver;
compare the detected pattern object to at least one stored pattern objects using a pre-programmed algorithm to determine a match using a digital signal processor;
transmit the detected pattern object to a determine a match using a database server;
transmit an information packet to the operator if a match is determined at the digital signal processor a database server, the informational packet corresponding a personal information of the detected pattern object; and

17. The methods of claim 7, wherein the digital signal processor is configured to at least crop a detected pattern object corresponding to a facial gesture.

18. The method of claim 8, wherein the plurality of stored information includes at least a personal information and an occupation.

19. The methods of claim 16, wherein the database server is further configured to configured to compare the detected object pattern to at least one social platform of the operator.

20. The method of claim 20, wherein the database further includes a receiver and transmitter to transmit a command signal to a responsive entity if a matched object pattern corresponding to an emergency is match.
